(19) United States
(12) Patent Application Publication
(10) Pub. No.: US 2009/0242292 A1
(43) Pub. Date: Oct. 1, 2009

(54) Method and system for operating an electric machine

(76) Inventors: Marcus Heller, Farmington Hills, MI (US); Robert Inderka, Birmingham, MI (US); Franz Nietfeld, Loningen (DE); Lars Weinschenker, Royal Oak, MI (US)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 12/079,936

(22) Filed: Mar. 28, 2008

(51) Int. Cl. B60W 10/08; B60W 20/00; H02P 27/06; H02H 7/093

(52) U.S. Cl. 180/65.275; 318/461; 318/801; 903/906; 318/465

(57) ABSTRACT

In a method for operating an electric machine which is coupled to a drive shaft, the electric machine is connected to a high voltage direct-current power supply line (HDVC) by a switch and the rotational speed of the connected electric machine or of the drive shaft coupled with the electric machine is determined and the electric machine is disconnected from the high-voltage direct-current power supply line (HVDC) when the rotational speed of the electric machine or, respectively, the driveshaft is above a predetermined threshold.

### BACKGROUND OF INVENTION

The present invention relates to a method and a system for operating an electric machine, used in an electrically powered vehicle, such as an electric vehicle (shortly named EV), a hybrid electric vehicle (shortly named HEV) or a fuel cell vehicle (FCV).

The need to reduce fossil fuel consumption and emissions in automobiles and other vehicles predominately powered by internal combustions engines (shortly named CE or ICE) is well known. Vehicles powered by electric machines attempt to address these needs. Another alternative solution is to use a smaller combustion engine together with electric machines for operating a vehicle. Such vehicles combine the advantages of a combustion engine vehicle and an electric vehicle and are typically called hybrid (electric) vehicle (shortly named HV or HEV).

The present invention relates to such a hybrid vehicle comprising a combustion engine and an electric motor (also called electric machine). As the use of electric machines in vehicle applications increases, robust reliable motor operation and performance are increasingly more important.

Hybrid vehicles have a variety of configurations. For example, a series hybrid electric vehicle (shortly named SHEV), parallel hybrid electrical vehicle (shortly named PHEV) and a parallel/series hybrid electric vehicle (shortly named PSHEV) are well known.

Other more useful configurations have been developed. For example, auxiliary electric drives, for driving pumps, for example oil pumps, power steering assist pumps, which are generally directly coupled with the crankshaft of the combustion engine, are directly energized from a high-voltage direct-current power line (shortly named HVDC power line) comprising a high-voltage power supply (shortly named HV power supply).

However, such auxiliary electric drives, especially permanently excited synchronous machine coupled directly with the crankshaft have limitations in operation modes with rotational speeds above a maximum threshold. In these operation modes with rotational speeds above a maximum threshold, for example when the combustion engine accelerates in an uncontrolled manner to excess rotational speeds, an uncontrolled current flow from the electric machine in generator mode to the HVDC power line could occur.

To avoid such uncontrolled current flow, a variety of different complex configurations are known:
the electric machine is designed in a way, that at the maximum rotational speed of crankshaft induced voltage of the electric machine is limited by the minimum HV power supply voltage (passive mode of control elements), or
the electric machine is controlled in the maximum rotational speed range in a way that the induced voltage of the controlled electric machine is limited by the minimum HV power supply voltage (=active mode of control elements).
Such designs and control functions of the electric machine limit the performance and efficiency of the electric machine.

### SUMMARY OF THE INVENTION

In a method for operating an electric machine which is coupled to a drive shaft, the electric machine is connected to a high voltage direct-current power supply line (HDVC) by a switch and the rotational speed of the connected electric machine or of the drive shaft coupled with the electric machine is determined and the electric machine is disconnected from the high-voltage direct-current power supply line (HVDC) when the rotational speed of the electric machine or, respectively, the driveshaft is above a predetermined threshold.

Such switching control of the electric machine allows that at maximum rotational speeds a high induced voltage of the electric machine is acceptable because the electric machine is disconnected from the HVDC power line under those conditions.

The present invention provides a strategy to operate an electric machine with improved robustness and reliability of operation and improved performance and efficiency of the electric machine.

A further advantage of the invention is that limitations of the electric machine, for example reduction of HEV control effort or potential system performance reduction are avoided. Reduction of high load occurrence will be beneficial in reliability of an HEV powertrain.

In accordance with a further aspect of the invention, the electric machine will be switched on to the HVDC power line when the instantaneous rotational speed is below said predetermined threshold. Thus, said electric machine can operate again when the instantaneous rotational speed is below said predetermined threshold and the electric machine is coupled to the HVDC power line.

In one embodiment of the invention the predetermined threshold is a maximum rotational speed. In other words: Switching off the electric machine is performed when a predetermined maximum rotational speed is exceeded. Typically the predetermined threshold is about 2400 rpm (=min⁻¹). The predetermined threshold can vary based on particular applications. For example, the predetermined threshold is in the range of about 600 rpm to about 2600 rpm.

Preferably, the present invention relates to an electric machine, in particular to a permanently excited synchronous machine.

The present invention also includes a system for operating an electric machine comprising:
a switching element for connecting the electric machine to a high-voltage direct-current power line,
an inverter for operating said connected electric machine,
means for determining a rotational speed of the connected electric machine or of a crankshaft coupled with the electric machine,
the switching element being controlled to switch off the electric machine from the HVDC power line if the instantaneous rotational speed is above a predetermined threshold.

The rotational speed of the connected electric machine can be determined without sensor by measuring the voltage of the electric machine.

If alternatively a sensor is used, the sensor can be a crankshaft rotational speed sensor or an electric machine rotational speed sensor. Alternatively, the sensor can also be a position sensor, especially an engine crankshaft position sensor or a transmission sensor.

In a further embodiment, the inverter is a three phase inverter comprising for each phase a pair of semiconductor devices, especially insulated-gate bipolar transistors (shortly named IGBT). The semiconductor devices can be also thyristors. Alternatively, the semiconductor devices are MOSFETs or diodes.

In accordance with a further aspect of the invention, the switching element is an insulated-gate bipolar transistor. In a further example, the switching element can be a thyristor or diode or an adequate integrated circuit.

The switching element can be arranged at an adequate position in the HVDC power line. One possible position is in a positive path of the HVDC power line. Alternatively, the switching element can be positioned in a negative path of the HVDC power line.

The invention can be used in hybrid electric vehicles, especially in parallel hybrid electric vehicles, serial hybrid electric vehicles or parallel/serial hybrid electric vehicles.

Below, exemplary embodiments of the present invention will be described with reference to the accompanying drawings. However, it should be understood that these embodiments are only examples of the many advantageous uses of the innovative teachings herein.

### BRIEF DESCRIPTION OF THE DRAWINGS

FIG. 1 shows a diagram of a system for operating an electric machine which is coupled via a crankshaft to a combustion engine.

### DETAILED DESCRIPTION

The present invention relates to electric machines. For demonstration purposes and to assist in understanding the present invention, it is described in a hybrid electric vehicle application.

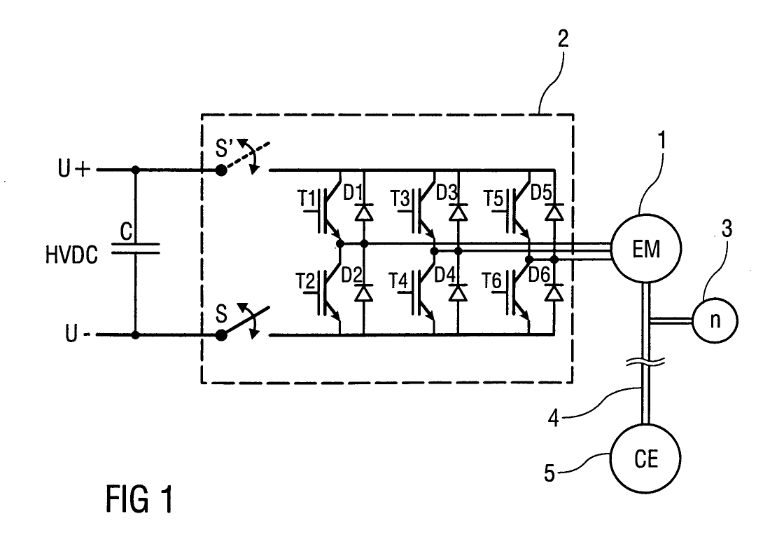

FIG. 1 demonstrates just one possible hybrid electric vehicle application. The hybrid electric vehicle comprises an electric machine 1 which is operated by a controllable inverter 2 and a switching element S. The electric machine 1, e.g. a permanently excited synchronous machine, is connected for example to an auxiliary electric drive, such as a pump, e.g. an oil pump or a power steering assist pump.

The electric machine 1 is coupled via a crankshaft 4 to a combustion engine 5. The electric machine 1 is further connected to a high-voltage direct-current power line HVDC (shortly named power line HVDC) via the inverter 2 and a positive path U₊ and a negative path U₋ of the power line HVDC. The power line HVDC comprises a high-voltage power supply C, for example electrochemical double layer capacitors (shortly named EDLC).

The inverter 2 is a three phase inverter which converts direct current to alternate current. The inverter 2 comprises for each phase a pair of insulated-gate bipolar transistors T1 to T6 in combination with pairs of diodes D1 to D6. Alternatively, the inverter 2 can contain as transistors T1 to T6 thyristors, MOSFETs (=metal oxide semiconductor field-effect transistors) or controllable diodes or other adequate controllable electronic components, especially semiconductor devices.

The switching element S can be positioned in the negative path U₋ of the power line HVDC. Alternatively, the switching element S′ can be positioned in the positive path U₊ (see dashed switching element S′). The switching element S or S′ can be a semiconductor element, for example a thyristor, a diode or an insulated-gate bipolar transistor or an adequate integrated circuit.

In operation of the vehicle, the electric machine 1 is connected to the power line HVDC. A sensor 3 determines a rotational speed n of the connected electric machine 1 or of the crankshaft 4 coupled with the electric machine 1. The sensor 3 can be a crankshaft rotational speed sensor or an electric machine rotational speed sensor.

During operation the sensor 3 determines the instantaneous rotational speed n of the electric machines 1 or of the crankshaft 4. If the sensor 3 determines that the rotational speed n is above a predetermined threshold, the electric machine 1 will be switched off from the power line HVDC by the switching element S. The predetermined threshold is especially a maximum rotational speed. The predetermined threshold may be variable, for example about 2400 rpm or in a range about 600 rpm to about 2600 rpm.

This switching function avoids that, at a possible maximum rotational speed of the electrical machine 1, an uncontrolled current flow from the electric machine 1 to the power line HVDC occurs.

If the sensor 3 determines that the instantaneous rotational speed n is below said predetermined threshold, the electric machine 1 will be re-connected on to the power line HVDC. The electric machine 1 is further normally operated by the controllable inverter 2 if the instantaneous rotational speed n is below said predetermined threshold and the electric machine 1 is coupled to the power line HVDC.

What is claimed is:

1. A method for operating an electric machine (1) comprising:
connecting the electric machine (1) to a high-voltage direct-current power line (HVDC),
operating said connected electric machine (1),
determining an instantaneous rotational speed (n) of the connected electric machine (1) or of a drive shaft (4) coupled with the electric machine (1),
disconnecting the electric machine (1) from the high-voltage direct-current power line (HVDC) if the instantaneous rotational speed (n) is above a predetermined threshold.

2. The method according to claim 1, further comprising:
connecting said electric machine (1) to the high-voltage direct-current power line (HVDC) when the instantaneous rotational speed (n) is below said predetermined threshold.

3. The method according to claim 1, further comprising:
operating said electric machine (1) when the instantaneous rotational speed (n) is below said predetermined threshold and the electric machine (1) is connected to the high-voltage direct-current power line (HVDC).

4. The method according to claim 1, wherein the predetermined threshold is in the range of 600 rpm to 2600 rpm.

5. The method according to claim 4, wherein the predetermined threshold is about 2400 rpm.

6. The method according to claim 1, wherein the electric machine (1) is a permanently excited synchronous machine.

7. A system for operating an electric machine (1) comprising:
a switching element (S, S′) for connecting the electric machine (1) to a high-voltage direct-current power line (HVDC),
an inverter (2) arranged between the switching element (5, 5′) and the electric machine (1) for operating said connected electric machine (1),
means (3) for determining a rotational speed (n) of the connected electric machine (1) or of a drive shaft (4) coupled with the electric machine (1),
the switching element (S, S′) being controlled to disconnect the electric machine (1) from a high-voltage direct-current power supply line (HVDC) when the instantaneous rotational speed (n) is above a predetermined threshold.

8. The system according to claim 7, wherein the means (3) for determining the rotational speed is a voltage sensor determining the rotational speed (n) based on the voltage of the electric machine.

9. The system according to claim 7, wherein the means (3) for determining the rotational speed is a rotational speed sensor sensing the speed of one of the driveshaft and the electric machine.

10. The system according to claim 7, wherein the inverter (2) comprises for each phase a pair of semiconductor devices.

11. The system according to claim 10, wherein the semiconductor devices are one of insulated-gate bipolar transistors (T1 to T6), thyristors, MOSFETS and diodes.

12. The system according to claim 7, wherein the switching element (S, S′) is one of a semiconductor element, an insulated-gate bipolar transistor, a thyristor and a diode.

13. The system according to claim 7, wherein the high voltage current power supply line (HVDC) includes a positive and a negative path and the switching element (S′) is positioned in at least one of the positive path (U₊) and the negative path (U₋) of the high-voltage direct-current power line (HVDC).

14. A hybrid vehicle including:
an electric machine (1),
a combustion engine (5) with a driveshaft (4) coupled to the electric machine (1),
a high-voltage direct-current power supply line (HVDC) for supplying electric power to the electric machine (1),
a switching element (S, S′) for connecting the electric machine to the high-voltage direct-current power supply line (HVDC),
an inverter (2) arranged between the switching element (S, S′) and the electric machine (1) for operating said electric machine (1) when the switching element (S, S′) is closed,
a sensor (3) for determining a rotational speed of the connected electric machine (1) or of the driveshaft (4) coupled with the electric machine (1),
the switching element (S, S′) being controlled to disconnect the electric machine (1) from the high-voltage direct-current power line (HVDC) when the rotational speed is above a predetermined threshold.
